(19) United States
(12) Patent Application Publication
(10) Pub. No.: US 2026/0328370 A1
(43) Pub. Date: Oct. 22, 2026

(54) FOLDABLE LIGHTED FRAME DEVICE

(71) Applicants: Vered SPIVAK, Tel Aviv (IL); Barak COHEN, Tel Aviv (IL)

(72) Inventors: Vered SPIVAK, Tel Aviv (IL); Barak COHEN, Tel Aviv (IL)

(21) Appl. No.: 19/468,708

(22) Filed: Feb. 3, 2026

Related U.S. Application Data
(60) Provisional application No. 63/753,760, filed on Feb. 4, 2025.

(51) Int. Cl. F21V 15/01; F21V 21/092; F21V 23/00; F21V 23/04; F21V 23/06; F21Y 115/10

(52) U.S. Cl. CPC F21V 15/012; F21V 21/092; F21V 23/006; F21V 23/04; F21V 23/06; F21Y 2115/10

(57) ABSTRACT

A foldable lighted frame device, comprising: a plurality of sections, each section having a front end and a back end; at least one folding mechanism interposed between at least two of the sections so as to couple the at least two sections together; a plurality of lighting elements, wherein at least two of the sections have at least one of the lighting elements on their respective front ends; and a plurality of attachment mechanisms, wherein at least two of the plurality of sections have at least one of the plurality of attachment mechanisms on their respective back ends; and wherein the sections and the folding mechanisms form a frame body of the foldable lighted frame device such that the at least one folding mechanism facilitates folding and unfolding of the frame body and when the frame body is unfolded it is in a substantially rigid and substantially planar configuration.

### CROSS REFERENCE TO RELATED APPLICATIONS

This application claims the benefit of U.S. Provisional Application No. 63/753,760 filed on Feb. 4, 2025, the contents of which are incorporated herein by reference.

### TECHNICAL FIELD

The present disclosure generally relates to portable lighting devices and, more specifically, to a foldable lighted frame device.

### BACKGROUND

Lighted mirrors, particularly those designed for makeup and grooming, have been staples of personal care for decades. Traditional vanity mirrors often integrate lighting to simulate natural daylight, aiding in the precise application of cosmetics and other detailed tasks.

These mirrors are generally stationary, fixed on a tabletop, wall, or integrated into larger furniture pieces. While highly functional, their bulk and immobility limit their use to specific locations.

Travel mirrors have emerged as portable alternatives, catering to those who require convenience and functionality on the go. Many of these compact mirrors incorporate battery-operated LED lights, offering an improved viewing experience even in low-light environments.

Despite their portability, travel mirrors often lack the size and versatility of larger vanity mirrors, forcing users to compromise on functionality for convenience. Therefore, it would be advantageous to provide a solution that overcomes the shortcomings of prior art solutions noted above.

### SUMMARY OF THE DISCLOSURE

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a foldable lighted frame device. The foldable lighted frame device comprises a plurality of sections, each section having a front end and a back end; at least one folding mechanism interposed between at least two of the sections so as to couple the at least two of the sections together; a plurality of lighting elements, wherein at least two of the plurality of sections have at least one of the plurality of lighting elements on their respective front ends; and a plurality of attachment mechanisms, wherein at least two of the plurality of sections have at least one of the plurality of attachment mechanisms on their respective back ends; and wherein the sections and the folding mechanisms form a frame body of the foldable lighted frame device such that the at least one folding mechanism facilitates folding and unfolding of the frame body and when the frame body is unfolded it is in a substantially rigid and substantially planar configuration.

Certain embodiments disclosed herein include a foldable lighted frame device. The foldable lighted frame device comprises a frame body including a plurality of sections, wherein the frame body comprises a front end and a back end, wherein the front end comprises a plurality of lighting elements, and wherein the back end comprises a plurality of attachment mechanisms; and at least one folding mechanism, wherein the at least one folding mechanism is interposed between each of the plurality of sections, and wherein the folding mechanism facilitates folding and unfolding of the frame body.

### BRIEF DESCRIPTION OF THE DRAWING

In the drawing:

FIG. 1A is a perspective view of a first illustrative embodiment of a foldable lighted frame device in an unfolded configuration as seen from its front;

FIG. 1B is a perspective view of the first illustrative embodiment of the foldable lighted frame device of FIG. 1A showing the back end of the foldable lighted frame device in an unfolded position;

FIG. 1C is a perspective view of the first illustrative embodiment of the foldable lighted frame device of FIG. 1A in a folded configuration;

FIG. 2A is a perspective view of a second illustrative embodiment of a foldable lighted frame device in an unfolded configuration as seen from its front;

FIG. 2B is a perspective view of the second illustrative embodiment of the foldable lighted frame device of FIG. 2A showing the back end of the foldable lighted frame device in an unfolded position;

FIG. 2C is a perspective view of the second illustrative embodiment of the foldable lighted frame device of FIG. 2A in a folded configuration;

FIG. 3A is a perspective view of a third illustrative embodiment of a foldable lighted frame device in an unfolded configuration as seen from its front;

FIG. 3B is a perspective view of the third illustrative embodiment of the foldable lighted frame device showing the back end of the foldable lighted frame device of FIG. 3A in an unfolded position;

FIG. 3C is a perspective view of the third illustrative embodiment of the foldable lighted frame device of FIG. 3A in a folded configuration;

FIG. 4A is a perspective view of a fourth illustrative embodiment of a foldable lighted frame device in an unfolded configuration as seen from its front;

FIG. 4B is a perspective view of the fourth illustrative embodiment of the foldable lighted frame device of FIG. 4A showing the back end of the foldable lighted frame device in an unfolded position;

FIG. 4C is a perspective view of the fourth illustrative embodiment of the foldable lighted frame device of FIG. 4A in a folded configuration; and

FIG. 5 is a block diagram of an illustrative circuit board that is embedded within a foldable lighted frame device.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A foldable lighted frame device includes a frame body having a plurality of sections, the frame body having a front end and a back end, the front end including a plurality of lighting elements, and the back end including a plurality of attachment mechanisms. The foldable lighted frame device includes one or more folding mechanisms, the folding mechanisms are positioned between each of the plurality of sections, and the folding mechanisms facilitate folding and unfolding of the frame body.

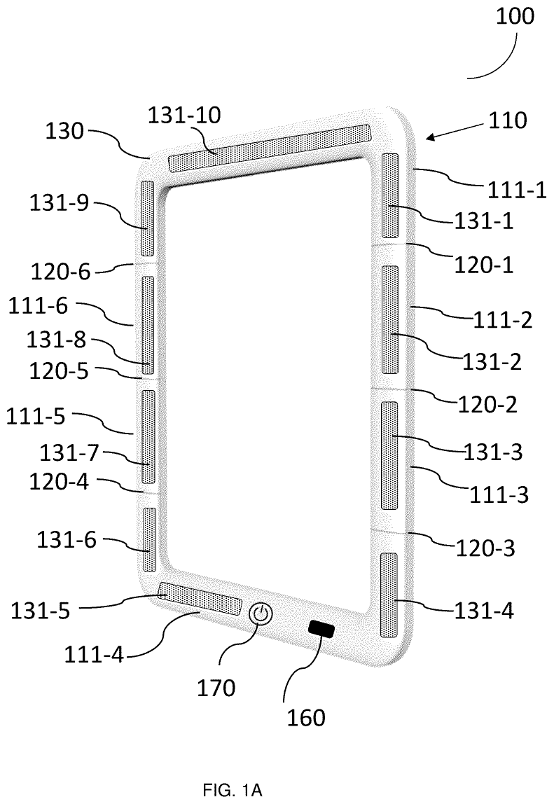

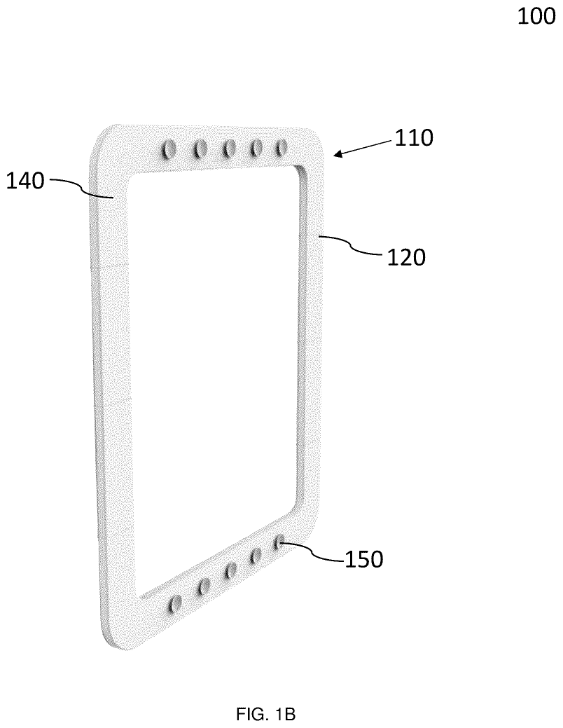

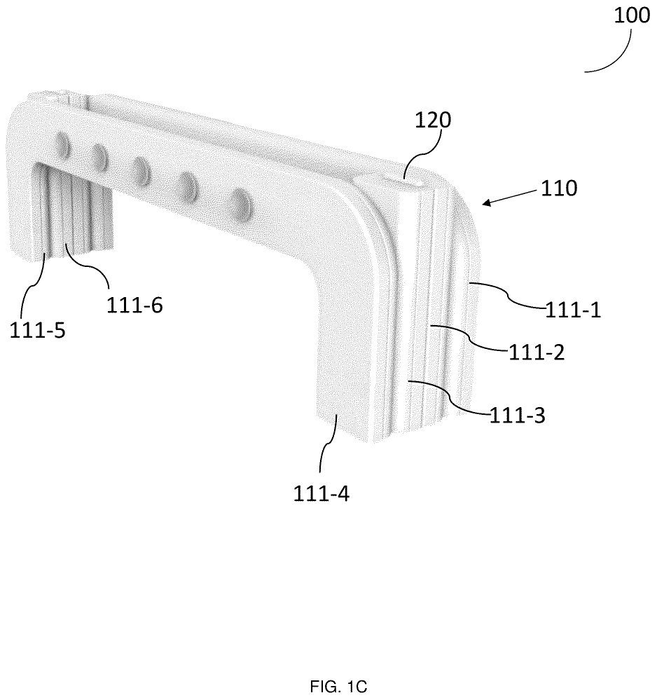

FIG. 1A is a perspective view of a first illustrative embodiment of a foldable lighted frame device 100 in an unfolded configuration as seen from its front. The frame device 100 includes a frame body 110 and at least one folding mechanism 120, such as the folding mechanism 120-1 through 120-6. According to one embodiment, the frame body 110 is made up of a plurality of sections 111, such as section 111-1 through section 111-6. FIG. 1A shows a front end 130 of frame body 110 in an unfolded configuration while FIG. 1B shows a back end 140 of frame body 110 in the same unfolded configuration.

The folding mechanism 120 performs two primary functions, the first is to connect the plurality of sections 111, and the second is to enable the folding and unfolding of the foldable lighted frame device 100. The folding mechanism 120 may be made from plastic, flexible polymer, rubber, silicone, springs, a combination thereof, and the like. Each of the folding mechanisms 120 allows relative angular movement between the two adjacent sections 111 connected thereby so that together the folding mechanisms 120 enable the frame to transition between an unfolded, generally planar configuration and a folded, compact configuration. Each individual one of the folding mechanisms 120 may be implemented in several well-known ways, which include, for example: a hinge or pivot structure with an axis allowing rotation between adjacent sections 111; a flexible or elastomeric connector, such as a flexible polymer, silicone, or rubber element, that allows bending between adjacent sections 111; a spring-based or resilient connector that permits folding while biasing the adjacent sections 111 toward an unfolded position; or combinations of the above. Within any embodiment, one or more of the folding mechanisms 120 may permit folding about one axis. Within any embodiment, one or more of the folding mechanisms 120 may permit folding about more than one axis. Within any embodiment only one type of folding mechanism may be employed or different types of folding mechanisms may be employed at the discretion of the implementer. It should be noted that the number of the folding mechanisms 120, as well as the number of sections 111, may vary between embodiments.

According to one embodiment, one or more of the sections 111 of the frame body 110 may be made from a rigid material. According to another embodiment, one or more of the sections 111 of the frame body may be made from at least partially elastic material. For example, one or more of the sections 111 of the frame body 110 may be made from wood, plastic, polyvinyl chloride (PVC), and the like. It should be noted that the frame body 110 may have a rectangular shape, a square shape, and the like.

The front end 130 includes a plurality of lighting elements, such as the lighting element 131-1 through lighting element 131-10. The plurality of lighting elements 131 may be light emitting diodes (LED), incandescent light bulbs, fluorescent lamps, halogen bulbs, a combination thereof, and the like. In an embodiment, ones of the lighting elements 131 may be incorporated into various ones of the plurality of sections 111-1 through 111-6 along the front end 130 of those of the sections 111 in which they are located.

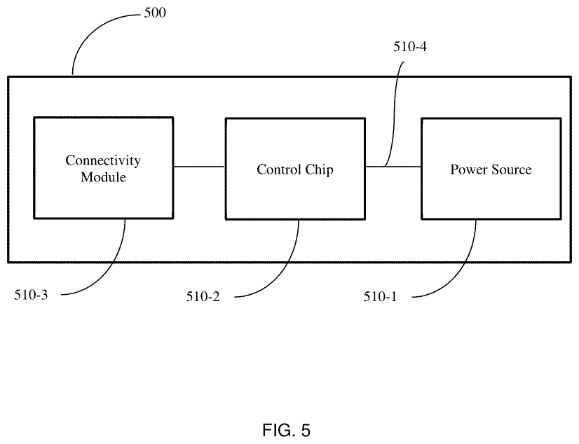

In one embodiment the foldable lighted frame device 100 includes a charging port 160, a power button 170, a circuit board (shown in FIG. 5), and a power source, e.g., a non-rechargeable battery or a rechargeable battery (not shown). The charging port 160 allows charging of the power source, e.g., a rechargeable battery of the foldable lighted frame device 100. In one embodiment the power button 170 includes a power indicator light.

FIG. 1B is a perspective view of the first illustrative embodiment of the foldable lighted frame device 100 showing the back end 140 of the foldable lighted frame device 100 in an unfolded position. The back end 140 includes a plurality of attachment mechanisms 150. The attachment mechanisms 150 may be made from rubber, silicone, adhesive, or other such flexible or sticky material, a combination thereof, and the like.

In one embodiment, the attachment mechanisms 150 are suction cups. Suction cups are designed to conform to substantially flat surfaces when they are compressed. When ones of the suction cups of a section 111 along back end 140 of the frame body 110 are pressed against a substantially flat surface, such as a mirror, a glass window, a wall cladding, e.g., by a person applying a modest compressive force sufficient to elastically deform the cups, the flexible material of the suction cups compresses. The compression expels air from between the cups and the surface, creating a seal. As a result, the frame body 110 is securely held in place on the surface by the suction cups. According to other embodiments, the attachment mechanisms 150 may be implemented as hooks, shafts, rails, a combination thereof, and the like. It should be noted that the number of the attachment mechanisms 150 and their position may vary between embodiments.

FIG. 1C is a perspective view of the first illustrative embodiment of the foldable lighted frame device 100 in a folded configuration. As noted above, the foldable lighted frame device 100 includes a frame body 110 and at least one folding mechanism 120. The frame body 110 includes a plurality of sections 111-1 through 111-6. In the unfolded state, the sections 111 are aligned so that collectively they form frame body 110 as a rigid structure suitable to be adhered to a flat surface. In the folded state, the sections 111 rotate or bend relative to one another via the folding mechanisms 120, allowing the frame 100 to collapse into a compact form such as may be placed in a small bag, a backpack, a drawer, and the like, e.g., for storage or transport.

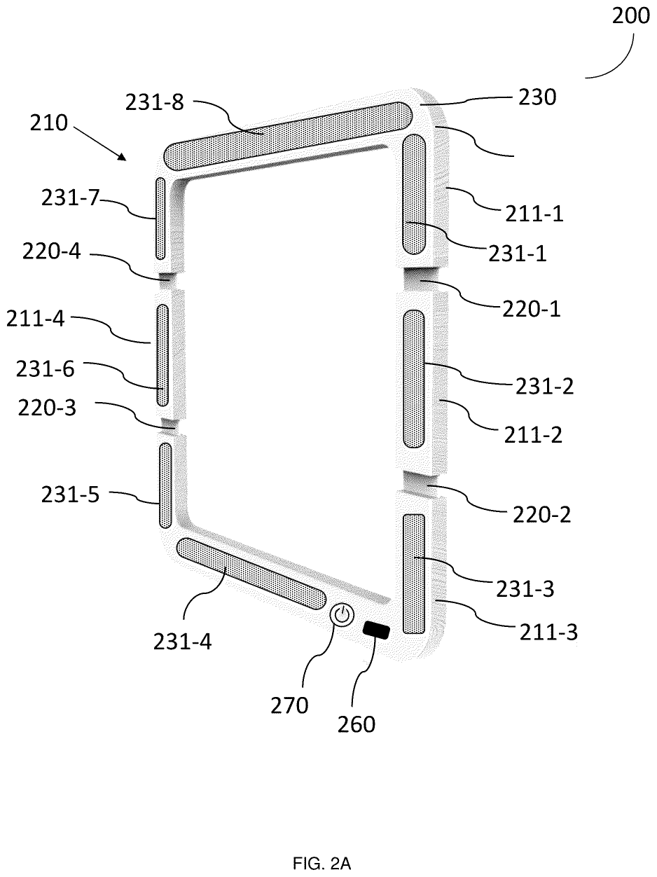

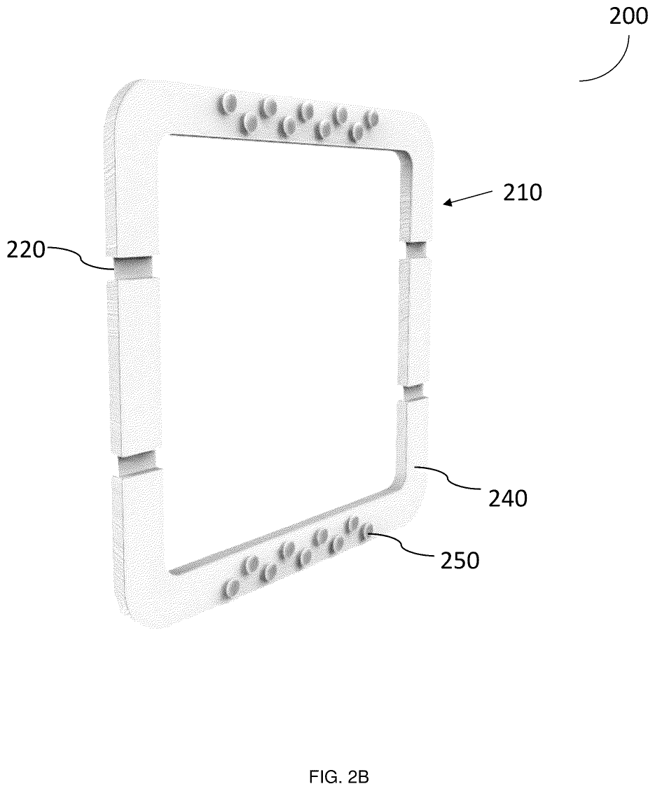

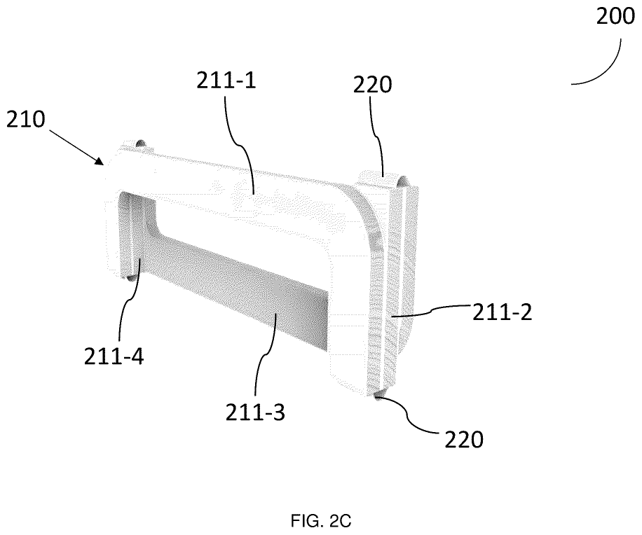

FIG. 2A is a perspective view of a second illustrative embodiment of a foldable lighted frame device 200 in an unfolded configuration as seen from its front. The frame device 200 includes a frame body 210 and at least one folding mechanism 220, such as the folding mechanism 220-1 through 220-4. According to one embodiment, the frame body 210 is made up of a plurality of sections 211, such as section 211-1 through section 211-4. FIG. 2A shows a front end 230 of frame body 210 in an unfolded configuration while FIG. 2B shows a back end 240 of frame body 210 in the same unfolded configuration.

The folding mechanism 220 performs two primary functions, the first is to connect the plurality of sections 211, and the second is to enable the folding and unfolding of the foldable lighted frame device 200. The folding mechanism 220 may be made from plastic, flexible polymer, rubber, silicone, springs, a combination thereof, and the like. Each of the folding mechanisms 220 allows relative angular movement between the two adjacent sections 211 connected thereby so that together the folding mechanisms 220 enable the frame to transition between an unfolded, generally planar configuration and a folded, compact configuration. Each individual one of the folding mechanisms 220 may be implemented in several well-known ways, which include, for example: a hinge or pivot structure with an axis allowing rotation between adjacent sections 211; a flexible or elastomeric connector, such as a flexible polymer, silicone, or rubber element, that allows bending between adjacent sections 211; a spring-based or resilient connector that permits folding while biasing the adjacent sections 211 toward an unfolded position; or combinations of the above. Within any embodiment, one or more of the folding mechanisms 220 may permit folding about one axis. Within any embodiment, one or more of the folding mechanisms 220 may permit folding about more than one axis. Within any embodiment only one type of folding mechanism may be employed or different types of folding mechanisms may be employed at the discretion of the implementer. It should be noted that the number of the folding mechanisms 220, as well as the number of sections 211, may vary between embodiments.

According to one embodiment, one or more of the sections 211 of the frame body 210 may be made from a rigid material. According to another embodiment, one or more of the sections 211 of the frame body may be made from at least partially elastic material. For example, one or more of the sections 211 of the frame body 210 may be made from wood, plastic, polyvinyl chloride (PVC), and the like. It should be noted that the frame body 210 may have a rectangular shape, a square shape, and the like.

The front end 230 includes a plurality of lighting elements, such as the lighting element 231-1 through lighting element 231-8. The plurality of lighting elements 231 may be light emitting diodes (LED), incandescent light bulbs, fluorescent lamps, halogen bulbs, a combination thereof, and the like. In an embodiment, ones of lighting elements 231 may be incorporated into various ones of the plurality of sections 211-1 through 211-4 along the front end 230 of those of the sections 211 in which they are located.

In one embodiment the foldable lighted frame device 200 includes a charging port 260, a power button 270, a circuit board (shown in FIG. 5), and a power source, e.g., a non-rechargeable battery or a rechargeable battery (not shown). The charging port 260 allows charging of the power source, e.g., a rechargeable battery of the foldable lighted frame device 200. In one embodiment the power button 270 includes a power indicator light.

FIG. 2B is a perspective view of the second illustrative embodiment of the foldable lighted frame device 200 showing the back end 240 of the foldable lighted frame device 200 in an unfolded position. The back end 240 includes a plurality of attachment mechanisms 250. The attachment mechanisms 250 may be made from rubber, silicone, adhesive, or other such flexible or sticky material, a combination thereof, and the like.

In one embodiment, the attachment mechanisms 250 are suction cups. Suction cups are designed to conform to substantially flat surfaces when they are compressed. When ones of the suction cups of a section 211 along back end 240 of the frame body 210 are pressed against a substantially flat surface, such as a mirror, a glass window, a wall cladding, e.g., by a person applying a modest compressive force sufficient to elastically deform the cups, the flexible material of the suction cups compresses. The compression expels air from between the cups and the surface, creating a seal. As a result, the frame body 210 is securely held in place on the surface by the suction cups. According to other embodiments, the attachment mechanisms 250 may implemented as hooks, shafts, rails, a combination thereof, and the like. It should be noted that the number of the attachment mechanisms 250 and their position may vary between embodiments.

FIG. 2C is a perspective view of the second illustrative embodiment of the foldable lighted frame device 200 in a folded configuration. As noted above, the foldable lighted frame device 200 includes a frame body 210 and at least one folding mechanism 220. The frame body 210 includes a plurality of sections 211-1 through 211-4. In the unfolded state, the sections 211 are aligned so that collectively they form frame body 210 as a rigid structure suitable to be adhered to a flat surface. In the folded state, the sections 211 rotate or bend relative to one another via the folding mechanisms 220, allowing the frame 200 to collapse into a compact form such as may be placed in a small bag, a backpack, a drawer, and the like, e.g., for storage or transport.

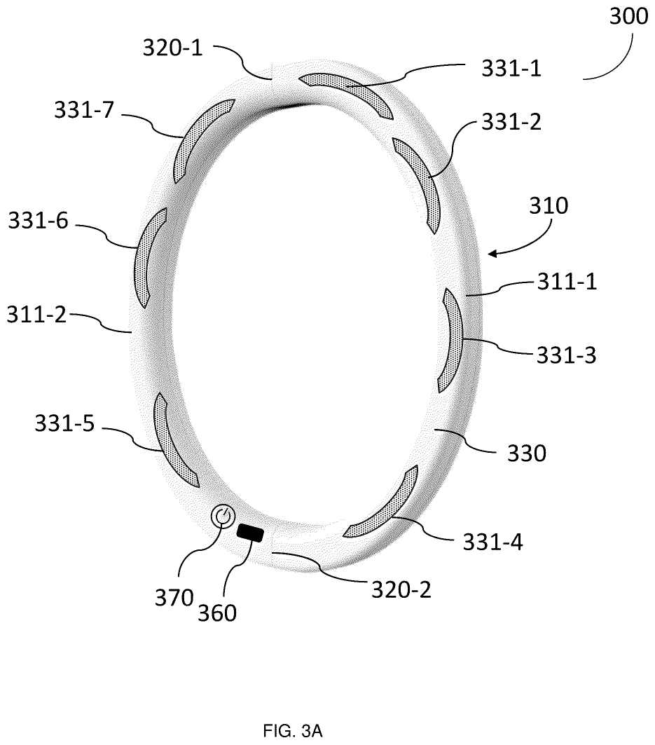

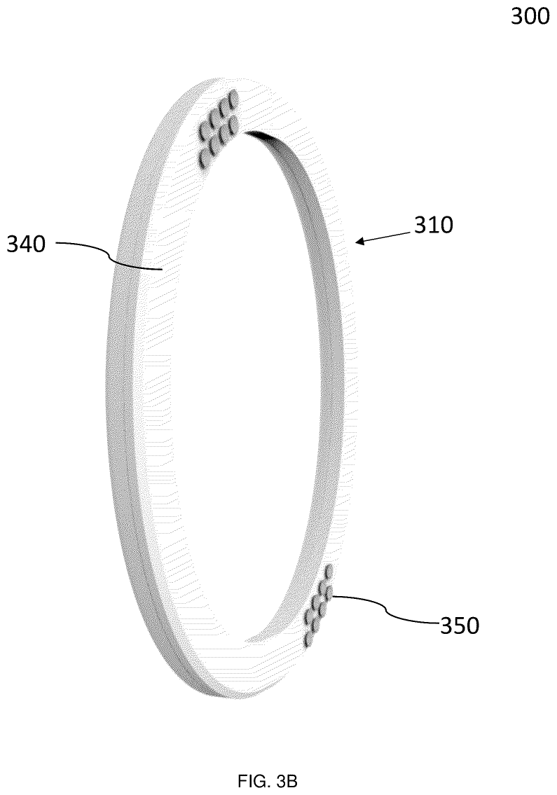

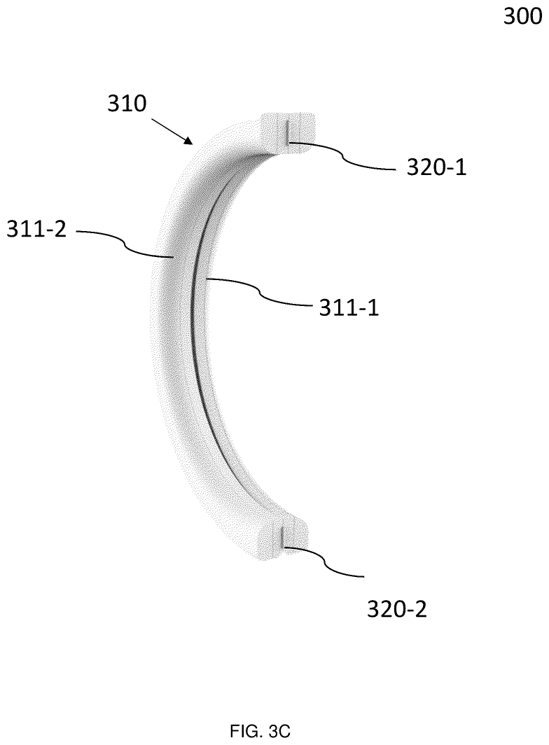

FIG. 3A is a perspective view of a third illustrative embodiment of a foldable lighted frame device 300 in an unfolded configuration as seen from its front. The frame device 300 includes a frame body 310 and at least one folding mechanism 320, such as the folding mechanism 320-1 through 320-2. According to one embodiment, the frame body 310 is made up of a plurality of sections 311, such as section 311-1 through section 311-2. FIG. 3A shows a front end 330 of frame body 310 in an unfolded configuration while FIG. 3B shows a back end 340 of frame body 310 in the same unfolded configuration.

The folding mechanism 320 performs two primary functions, the first is to connect the plurality of sections 311, and the second is to enable the folding and unfolding of the foldable lighted frame device 300. The folding mechanism 320 may be made from plastic, flexible polymer, rubber, silicone, springs, a combination thereof, and the like. Each of the folding mechanisms 320 allows relative angular movement between the two adjacent sections 311 connected thereby so that together the folding mechanisms 320 enable the frame to transition between an unfolded, generally planar configuration and a folded, compact configuration. Each individual one of the folding mechanisms 320 may be implemented in several well-known ways, which include, for example: a hinge or pivot structure with an axis allowing rotation between adjacent sections 311; a flexible or elastomeric connector, such as a flexible polymer, silicone, or rubber element, that allows bending between adjacent sections 311; a spring-based or resilient connector that permits folding while biasing the adjacent sections 311 toward an unfolded position; or combinations of the above. Within any embodiment, one or more of the folding mechanisms 320 may permit folding about one axis. Within any embodiment, one or more of the folding mechanisms 320 may permit folding about more than one axis. Within any embodiment only one type of folding mechanism may be employed or different types of folding mechanisms may be employed at the discretion of the implementer. It should be noted that the number of the folding mechanisms 320, as well as the number of sections 311, may vary between embodiments.

According to one embodiment, one or more of the sections 311 of the frame body 310 may be made from a rigid material. According to another embodiment, one or more of the sections 311 of the frame body may be made from at least partially elastic material. For example, one or more of the sections 311 of the frame body 310 may be made from wood, plastic, polyvinyl chloride (PVC), and the like. It should be noted that the frame body 310 may have a circular shape, an oval shape, and the like.

The front end 330 includes a plurality of lighting elements, such as the lighting element 331-1 through lighting element 331-7. The plurality of lighting elements 331 may be light emitting diodes (LED), incandescent light bulbs, fluorescent lamps, halogen bulbs, a combination thereof, and the like. In an embodiment, ones of the lighting elements 331 may be incorporated into various ones of the plurality of sections 311-1 through 311-2 along the front end 330 of those of the sections 311 in which they are located.

In one embodiment the foldable lighted frame device 300 includes a charging port 360, a power button 370, a circuit board (shown in FIG. 5), and a power source, e.g., a non-rechargeable battery or a rechargeable battery (not shown). The charging port 360 allows charging of the power source, e.g., a rechargeable battery of the foldable lighted frame device 300. In one embodiment the power button 370 includes a power indicator light.

FIG. 3B is a perspective view of the third illustrative embodiment of the foldable lighted frame device 300 showing the back end 340 of the foldable lighted frame device 300 in an unfolded position. The back end 340 includes a plurality of attachment mechanisms 350. The attachment mechanisms 350 may be made from rubber, silicone, adhesive, or other such flexible or sticky material, a combination thereof, and the like.

In one embodiment, the attachment mechanisms 350 are suction cups. Suction cups are designed to conform to substantially flat surfaces when they are compressed. When ones of the suction cups of a section 311 along back end 340 of the frame body 310 are pressed against a substantially flat surface, such as a mirror, a glass window, a wall cladding, e.g., by a person applying a modest compressive force sufficient to elastically deform the cups, the flexible material of the suction cups compresses. The compression expels air from between the cups and the surface, creating a seal. As a result, the frame body 310 is securely held in place on the surface by the suction cups. According to other embodiments, the attachment mechanisms 350 may be implemented as hooks, shafts, rails, a combination thereof, and the like. It should be noted that the number of the attachment mechanisms 350 and their position may vary between embodiments.

FIG. 3C is a perspective view of the third illustrative embodiment of the foldable lighted frame device 300 in a folded configuration. As noted above, the foldable lighted frame device 300 includes a frame body 310 and at least one folding mechanism 320. The frame body 310 includes a plurality of sections 311-1 through 311-2. In the unfolded state, the sections 311 are aligned so that collectively they form frame body 310 as a rigid structure suitable to be adhered to a flat surface. In the folded state, the sections 311 rotate or bend relative to one another via the folding mechanisms 320, allowing the frame 300 to collapse into a compact form such as may be placed in a small bag, a backpack, a drawer, and the like, e.g., for storage or transport.

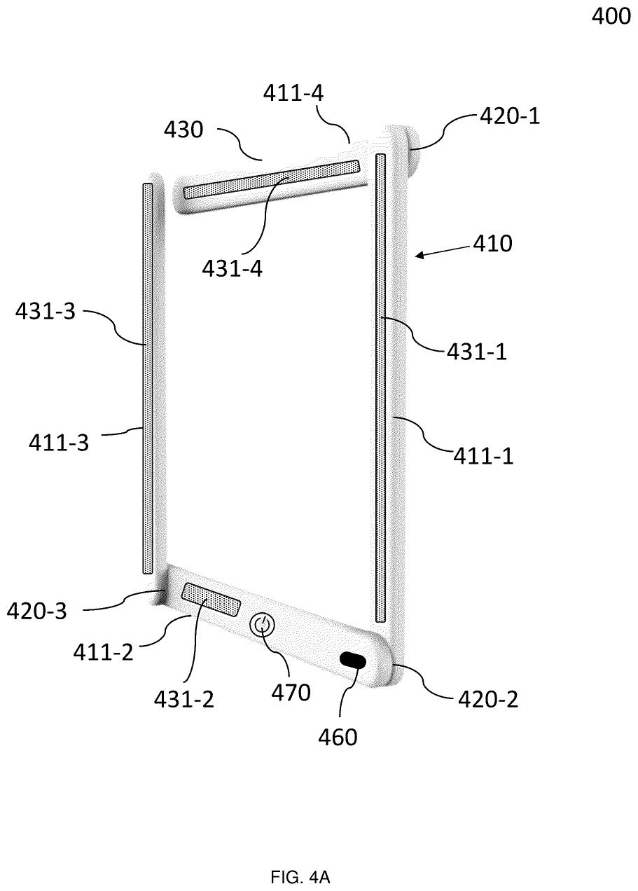

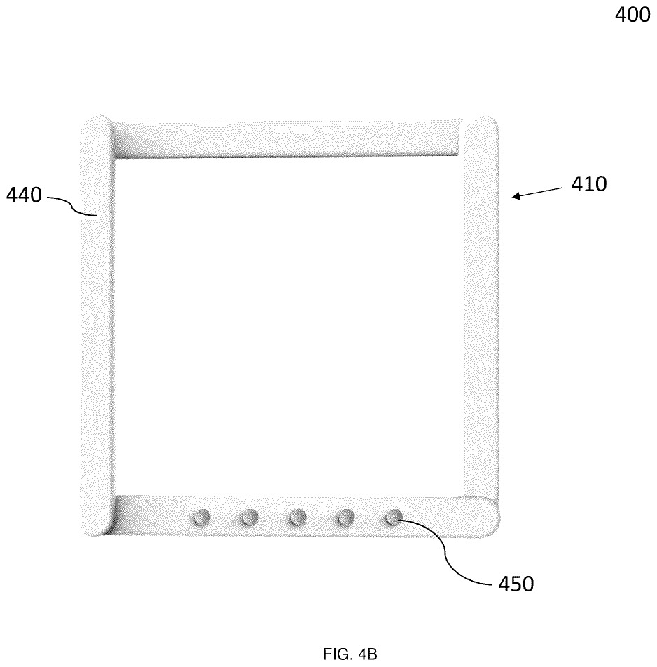

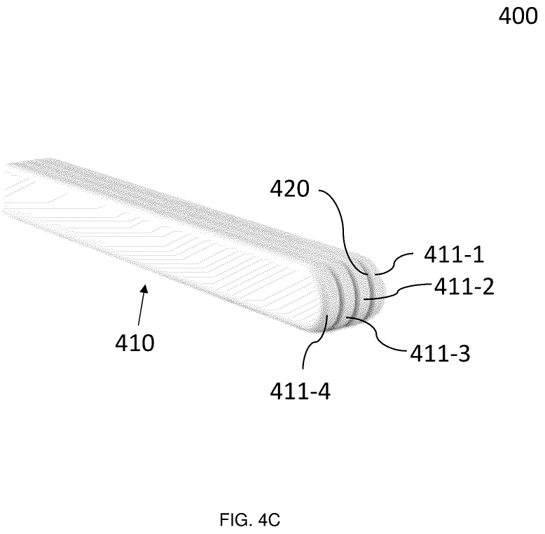

FIG. 4A is a perspective view of a fourth illustrative embodiment of a foldable lighted frame device 400 in an unfolded configuration as seen from its front. The frame device 400 includes a frame body 410 and at least one folding mechanism 420, such as the folding mechanism 420-1 through 420-3. According to one embodiment, the frame body 410 is made up of a plurality of sections 411, such as section 411-1 through section 411-4. FIG. 4A shows a front end 430 of frame body 410 in an unfolded configuration while FIG. 4B shows a back end 440 of frame body 410 in the same unfolded configuration.

The folding mechanism 420 performs two primary functions, the first is to connect the plurality of sections 411, and the second is to enable the folding and unfolding of the foldable lighted frame device 400. The folding mechanism 420 may be made from plastic, flexible polymer, rubber, silicone, springs, a combination thereof, and the like. Each of the folding mechanisms 420 allows relative angular movement between the two adjacent sections 411 connected thereby so that together the folding mechanisms 420 enable the frame to transition between an unfolded, generally planar configuration and a folded, compact configuration. Each individual one of the folding mechanisms 420 may be implemented in several well-known ways, which include, for example: a hinge or pivot structure with an axis allowing rotation between adjacent sections 411; a flexible or elastomeric connector, such as a flexible polymer, silicone, or rubber element, that allows bending between adjacent sections 411; a spring-based or resilient connector that permits folding while biasing the adjacent sections 411 toward an unfolded position; or combinations of the above. Within any embodiment, one or more of the folding mechanisms 420 may permit folding about one axis. Within any embodiment, one or more of the folding mechanisms 420 may permit folding about more than one axis. Within any embodiment only one type of folding mechanism may be employed or different types of folding mechanisms may be employed at the discretion of the implementer. It should be noted that the number of the folding mechanisms 420, as well as the number of sections 411, may vary between embodiments.

According to one embodiment, part of the sections 411-1 through 411-4 are not connected. According to a further embodiment, sections 411-1 and 411-4 are held together by at least one attachment element (not shown). Such attachment elements may be made from magnets, rubber, silicone, adhesive, or any other flexible, sticky material, hook-and-loop fastener, e.g., Velcro®, a combination thereof, and the like. For example, the attachment element may be implemented as springs, a combination thereof, and the like.

According to one embodiment, one or more of the sections 411 of the frame body 410 may be made from a rigid material. According to another embodiment, one or more of the sections 411 of the frame body may be made from at least partially elastic material. For example, one or more of the sections 411 of the frame body 410 may be made from wood, plastic, polyvinyl chloride (PVC), and the like. It should be noted that the frame body 410 may have a circular shape, an oval shape, and the like.

The front end 430 includes a plurality of lighting elements, such as the lighting element 431-1 through lighting element 431-4. The plurality of lighting elements 431 may be light emitting diodes (LED), incandescent light bulbs, fluorescent lamps, halogen bulbs, a combination thereof, and the like. In an embodiment, ones of the lighting elements 431 may be incorporated into various ones of the plurality of sections 411-1 through 411-4 along the front end 430 of those of the sections 411 in which they are located.

In one embodiment the foldable lighted frame device 400 includes a charging port 460, a power button 470, a circuit board (shown in FIG. 5), and a power source, e.g., a non-rechargeable battery or a rechargeable battery (not shown). The charging port 460 allows charging of the power source, e.g., a rechargeable battery of the foldable lighted frame device 400. In one embodiment the power button 470 includes a power indicator light.

FIG. 4B is a perspective view of the fourth illustrative embodiment of the foldable lighted frame device 400 showing the back end 440 of the foldable lighted frame device 400 in an unfolded position. The back end 440 includes a plurality of attachment mechanisms 450. The attachment mechanisms 450 may be made from rubber, silicone, adhesive, or other such flexible or sticky material, a combination thereof, and the like.

In one embodiment, the attachment mechanisms 450 are suction cups. Suction cups are designed to conform to substantially flat surfaces when they are compressed. When ones of the suction cups of a section 411 along back end 440 of the frame body 410 are pressed against a substantially flat surface, such as a mirror, a glass window, a wall cladding, e.g., by a person applying a modest compressive force sufficient to elastically deform the cups, the flexible material of the suction cups compresses. The compression expels air from between the cups and the surface, creating a seal. As a result, the frame body 410 is securely held in place on the surface by the suction cups. According to other embodiments, the attachment mechanisms 450 may be implemented as hooks, shafts, rails, a combination thereof, and the like. It should be noted that the number of the attachment mechanisms 450 and their position may vary between embodiments.

FIG. 4C is a perspective view of the fourth illustrative embodiment of the foldable lighted frame device 400 in a folded configuration. As noted above, the foldable lighted frame device 400 includes a frame body 410 and at least one folding mechanism 420. The frame body 410 includes a plurality of sections 411-1 through 411-4. In the unfolded state, the sections 411 are aligned so that collectively they form frame body 410 as a rigid structure suitable to be adhered to a flat surface. In the folded state, the sections 411 rotate or bend relative to one another via the folding mechanisms 420, allowing the frame 400 to collapse into a compact form such as may be placed in a small bag, a backpack, a drawer, and the like, e.g., for storage or transport.

In some embodiments, rigidity of the frame body arises from cooperative alignment of the sections regardless of the material employed for the sections, i.e., even when one or more of the sections do not employ rigid materials.

FIG. 5 is a block diagram of an illustrative circuit board that is embedded within a foldable lighted frame device, e.g., the foldable lighted frame device 100 through foldable lighted frame device 400. The circuit board 500 may include at least a power source 510-1, at least one control chip 510-2, and at least one connectivity module 510-3. The various components of the circuit board 500 may be connected via a bus 510-4.

The power source 510-1 may be for example, a battery, an external power supply, and the like. The power source 510-1 is configured to supply electric power to the circuit board 500, thereby allowing the operation of the circuit board 500. The connectivity module 510-3 may include for example, wired or wireless communication, such as Bluetooth, Near Field Communication (NFC), and the like. The control chip 510-2 is configured to receive operational signals issued by a user device, e.g., smartphone, a wearable device, and the like, using the connectivity module 510-3, and execute actions specified by the operational signals. The operational signals may include, for example, turning on or off the lighting elements, change the lighting color, adjusting the light intensity, and the like.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A foldable lighted frame device, comprising:
a plurality of sections, each section having a front end and a back end;
at least one folding mechanism interposed between at least two of the sections so as to couple the at least two of the sections together;
a plurality of lighting elements, wherein at least two of the plurality of sections have at least one of the plurality of lighting elements on their respective front ends; and
a plurality of attachment mechanisms, wherein at least two of the plurality of sections have at least one of the plurality of attachment mechanisms on their respective back ends; and
wherein the sections and the folding mechanisms form a frame body of the foldable lighted frame device such that the at least one folding mechanism facilitates folding and unfolding of the frame body and when the frame body is unfolded it is in a substantially rigid and substantially planar configuration.

2. The foldable lighted frame device of claim 1, wherein the attachment mechanisms are adapted to retain the planar configuration substantially rigidly against a substantially flat surface.

3. The foldable lighted frame device of claim 1, wherein, when the frame body is unfolded, a space is formed interior to the plurality of sections and the at least one folding mechanism.

4. The foldable lighted frame device of claim 1, further comprising a circuit board that at least controls operation of the lighting elements.

5. The foldable lighted frame device of claim 4, further comprising a charging port, the charging port being coupled to the circuit board.

6. The foldable lighted frame device of claim 4, further comprising a power button, the power button being coupled to the circuit board.

7. The foldable lighted frame device of claim 4, wherein the circuit board comprises a connectivity module, wherein the connectivity module receives operational signals and wherein the circuit board causes actions in response to received operational signals.

8. The foldable lighted frame device of claim 1, wherein at least one of the folding mechanisms is made from at least one of plastic, flexible polymer, rubber, silicone, and springs.

9. The foldable lighted frame device of claim 1, wherein at least one of the folding mechanisms allows relative angular movement between the ones of the sections that the at least one of the folding mechanisms is located between.

10. The foldable lighted frame device of claim 1, wherein at least one of the folding mechanisms is one of a hinge or pivot structure having at least one axis that enables rotation between the ones of the sections that the at least one of the folding mechanisms is located between.

11. The foldable lighted frame device of claim 1, wherein at least one of the folding mechanisms is a flexible connector that enables bending the ones of the sections that the at least one of the folding mechanisms is located between.

12. The foldable lighted frame device of claim 11, wherein flexible connector is comprised of at least one of a flexible polymer, silicone, and rubber element.

13. The foldable lighted frame device of claim 1, wherein at least one section is comprised of at least partially elastic material.

14. The foldable lighted frame device of claim 1, wherein at least one section is comprised of at least a rigid material.

15. The foldable lighted frame device of claim 14, wherein the rigid material is at least one of wood, plastic, and polyvinyl chloride.

16. The foldable lighted frame device of claim 1, wherein in an unfolded configuration the frame body is at least one of rectangular shaped, square shaped, round shaped, and oval shaped.

17. The foldable lighted frame device of claim 1, wherein the attachment mechanisms are at least one of suction cups, hooks, shafts, and rails.

18. A foldable lighted frame device, comprising:
a frame body including a plurality of sections, wherein the frame body comprises a front end and a back end, wherein the front end comprises a plurality of lighting elements, and wherein the back end comprises a plurality of attachment mechanisms; and
at least one folding mechanism, wherein the at least one folding mechanism is interposed between each of the plurality of sections, and wherein the folding mechanism facilitates folding and unfolding of the frame body.

19. The foldable lighted frame device of claim 18, wherein the at least one folding mechanism is made from at least one of plastic, flexible polymer, rubber, silicone, and springs.

20. The foldable lighted frame device of claim 18, wherein the at least one folding mechanism allows relative angular movement between the ones of the sections that the at least one folding mechanisms is located between.

21. The foldable lighted frame device of claim 18, wherein the at least one folding mechanism is one of a hinge or pivot structure having at least one axis that enables rotation between the ones of the sections that the at least one folding mechanism is located between.

22. The foldable lighted frame device of claim 18, wherein at least one folding mechanism is a flexible connector that enables bending the ones of the sections that the at least one of the folding mechanisms is located between.
